(19) United States
(12) Patent Application Publication
(10) Pub. No.: US 2007/0009357 A1
(43) Pub. Date: Jan. 11, 2007

(54) LED fan clip giving circular light bar during fan operation

(76) Inventor: David Mark Solak, Seven Hills, OH (US)

Correspondence Address: David M. Solak, 4805 Maple Hill Drive, Seven Hills, OH, 44131-5916, US

(21) Appl. No.: 11/175,069

(22) Filed: Jul. 5, 2005

(51) Int. Cl. F03D 11/00

(52) U.S. Cl. 416/5

(57) ABSTRACT

Many people like to enhance their surroundings by decoration and setting lights and displays. The invention described in this application intends to give a novel effect to a spinning fan mainly during the later hours of a day. When a fan spins with a glowing light attached to one or all of it's blades, a strobe or circular even elliptical light appears. It may be pleasing to one's eye and desirable as an interesting characteristic to a fan. The invention could even aid in one's navigation about the room in pitch dark. The device consists of a small housing about one by two inches in dimension. The housing encloses a gravity switch to operate the light on and off, a battery compartment with a cap to house the power source, a clip with a special tip to help fasten the whole assembly to the fan blade, and circuitry that can be designed to operate multi-colored LEDs.

### FIELD OF INVENTION

This invention will give a special lighting effect when clipped to a fan blade, namely a ceiling fan. The circular light given during fan operation may be a desirable effect for those interested in novelty lights and toys. The LED housing attaches to the fan blade(s) buy a clip with friction grips. A gravity type switch wired between the battery and the LED circuit will turn on the LED when the blade begins to spin. The switch will turn off the LED when fan speed is null. A multiple-color LED may be used to change colors during operation.

### DESCRIPTION OF PRIOR ART

A device described in Patent U.S. Pat. No. 6,790,003 issued Sep. 14, 2004 to Hu et al. involves LEDs' and fans except the LED does not attach to the blade. The fan does not intend to cool a room, but more typically electronic components such as those found in computers. There is a device in prior art U.S. Pat. No. 6,367,942 issued Apr. 9, 2002 to Bauer that features chemiluminescent light that are housed or characterized as sticks, necklaces, bracelets, swizzle sticks and more. The invention in this application is a special design with a built-in clip and a battery to power it's light source. Furthermore, the light is turned on and off on its own accord. A image display apparatus is described in Patent U.S. Pat. No. 6,175,354 issued Jan. 16, 2001 to Blisset et al. This device is much more sophisticated than the device of this application. The device has fixed lights fastened to the fan blade through holes in the blade. The intention of the LED device described and being applied for is to be removable and placed on the edge of the fan blade. lacovino invented a fan balancing apparatus U.S. Pat. No. 5,380,156 issued Jan. 10, 1995. The device focuses on leveling or balancing the blades with a fluid-filled tube. No light source is incorporated into the device. The invention described in this application does not intend to have a balancing effect and does not incorporate any fluid.

### SUMMARY OF INVENTION

This invention will provide a circular bar of light while the fan blades are spinning. The light is most visible at night. A clip under tension from a spring has a friction point that grabs the fan blade for a secure grip so the LED housing is not prone to coming off during fan operation due to the effects of rotational forces. A gravity switch located inside the housing consists mainly of two metal blades and two weights, or “pellets” that will be wired between the LED and it's circuit and the battery. The two weights will allow the device to operate clockwise or counter-clockwise. A battery cap will conceal the battery when the battery is placed in the receptacle or battery compartment. When the fan begins to spin, the rotational forces will cause the metal blades of the gravity switch to close and complete the circuit. The metal blades open to turn off the LED when the fan stops. The whole assembly can be placed anywhere on the fan blade's edge.

### BRIEF DESCRIPTION OF DRAWINGS

FIG. 1. Shows a fan with a setup of the device. Multiple devices can be placed on the fan.

FIG. 2. Shows a fan at a side view, and how the device would clip onto a blade.

FIG. 3. A side view of the LED device showing the battery cap.

FIG. 4 A section view showing battery area, gravity switch, LED and clip.

FIG. 5. A Top view of the device showing clip.

FIG. 6. Is a schematic of the LED circuit.

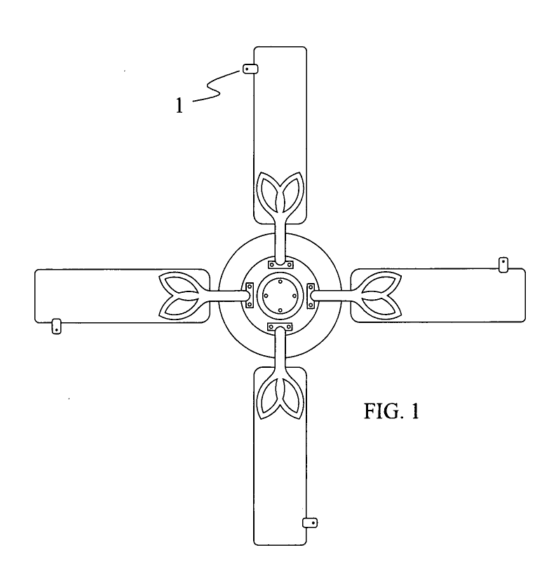

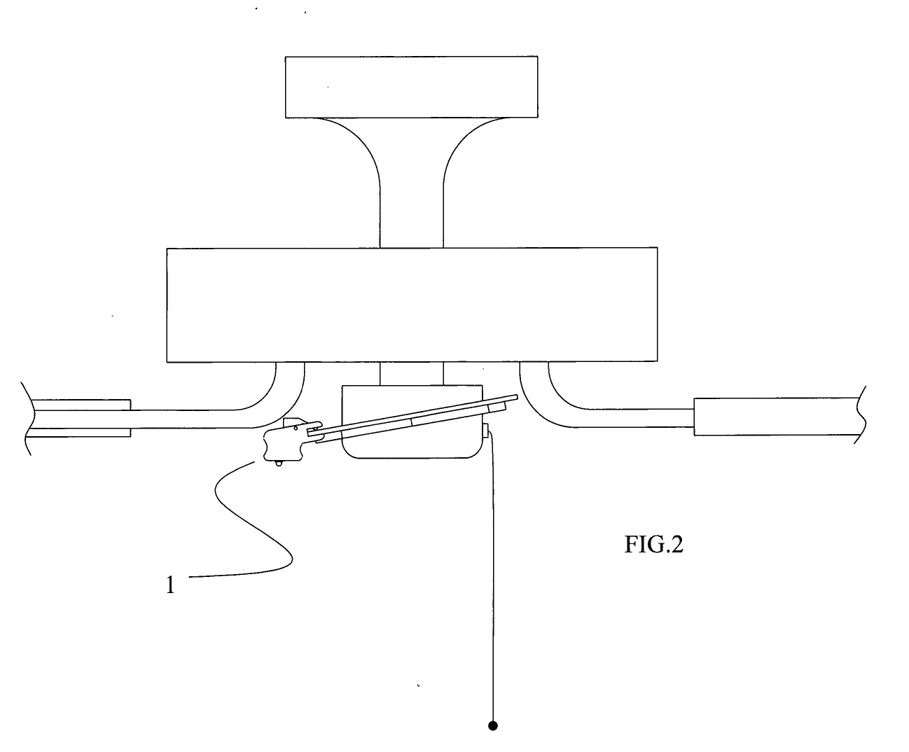

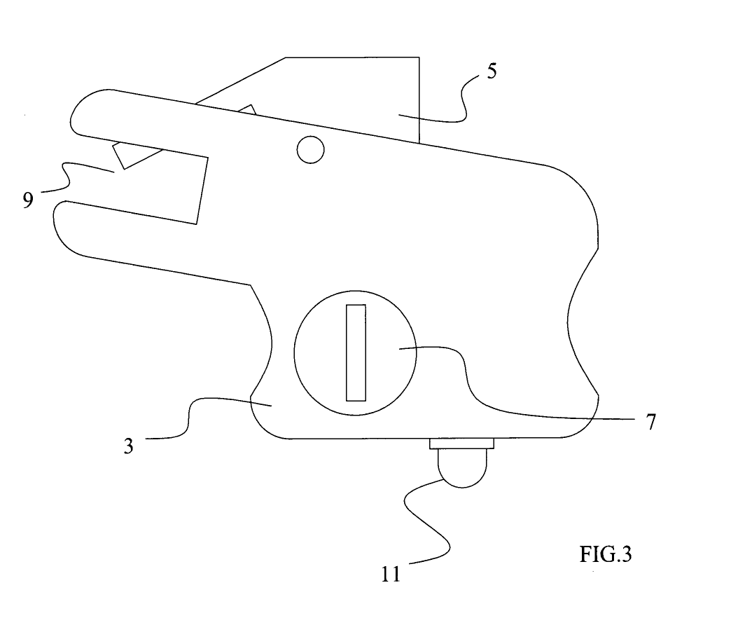

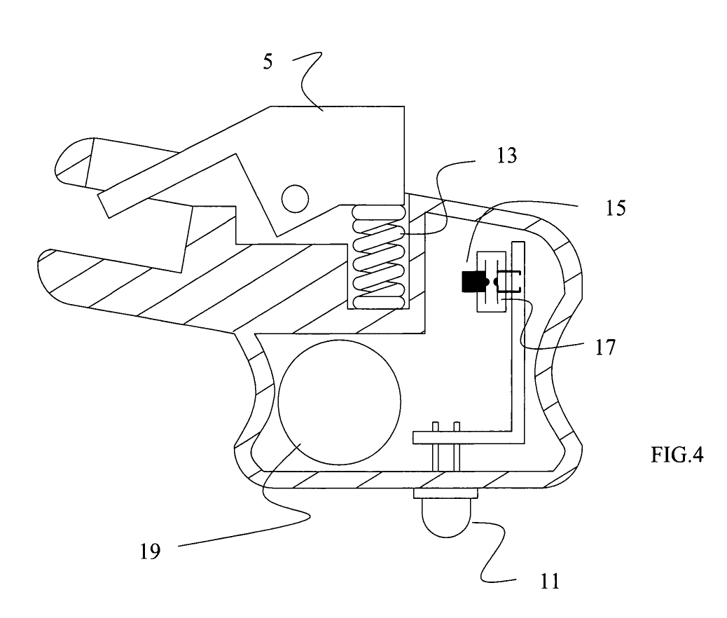

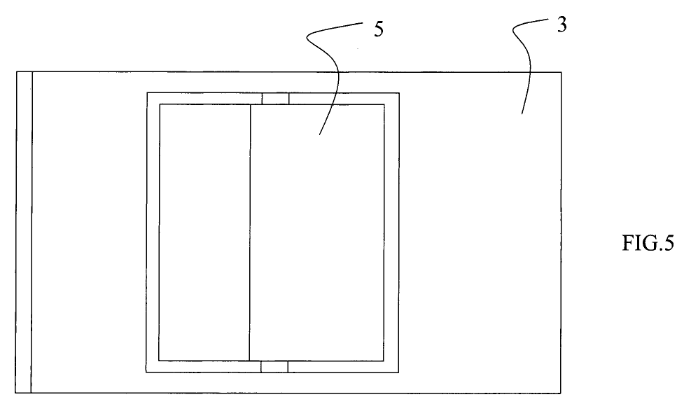

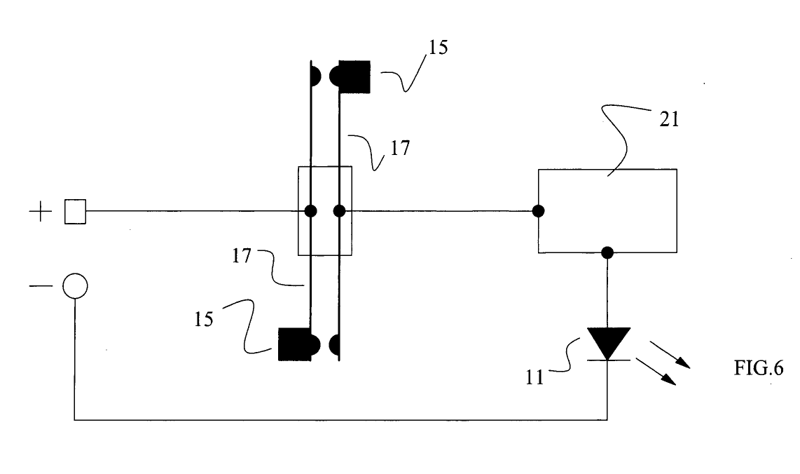

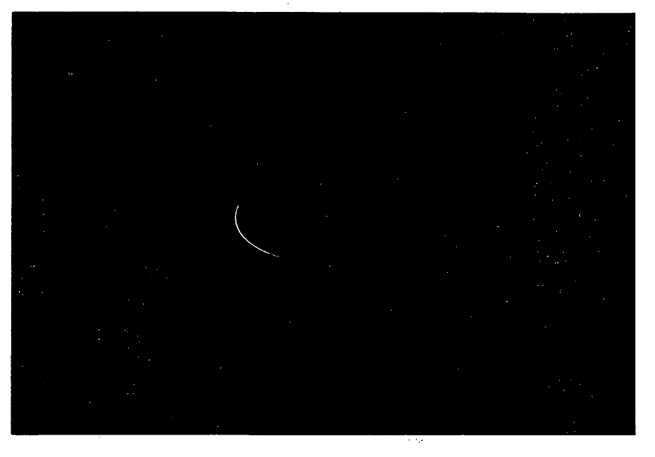

### DETAILED DESCRIPTION OF DRAWINGS

This device when attached to a fan blade intends to light an LED 11 when the fan blades begin to spin. A gravity switch incorporating two metal blades 17 and two weights 15 will close and complete a circuit 21 to light an LED 11. The two weights 15 allow for clockwise and counter-clockwise operation. A battery compartment 19 has a cap 7 that conceals a battery. A clip 5 under tension from a spring 13 will secure the whole assembly 1 to the fan blade. The clip 5 has a friction point 9 to help secure the whole assembly 1 to the fan blade. A housing 3 encloses the circuit 21, battery, spring 13 and gravity switch with blades 17 and weights 15.

I claim:

1. A light emitting device, comprising:
a. a housing to enclose circuitry that controls a light source such as a light emitting diode powered by a battery, whereas
b. said housing incorporates a clip under tension from a spring to securely hold the housing in place on a fan blade's edge, and
c. said battery has a compartment and is concealed by a cap for aesthetic purposes, and
d. located inside said housing is a gravity type switch causing the LED to turn on and off automatically upon starting the fan, whereas
e. said gravity switch consists mainly of spring type metal blades to flex and recoil under force, and
f. located on spring type blades are two weights to increase loading on blades when rotational force is applied to the gravity type switch
